(19) United States
(12) Patent Application Publication
(10) Pub. No.: US 2004/0003411 A1
(43) Pub. Date: Jan. 1, 2004

(54) Image service system

(75) Inventors: Masaaki Nakai, Suita-Shi (JP); Yuichi Kawakami, Nishinomiya-Shi (JP); Tomoyuki Terada, Toyonaka-Shi (JP); Masaru Sawada, Suita-Shi (JP); Natsuko Shiota, Hirakata-Shi (JP); Naotaka Kishida, Sakai-Shi (JP); Ayumi Itoh, Ikoma-gun (JP); Shinji Sakai, Kawanishi-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/607,879

(22) Filed: Jun. 27, 2003

(30) Foreign Application Priority Data
Jun. 28, 2002 (JP) 2002-190958
Jun. 28, 2002 (JP) 2002-190766

(51) Int. Cl. H04N 7/173

(52) U.S. Cl. 725/105

(57) ABSTRACT

An image service system includes an imaging unit for capturing an image of an object; and a server for storing a plurality of images captured by the imaging unit and selecting one or more desired images from the stored images. The server transmits the selected images or information associated with the selected images via a network to a terminal.

### RELATED APPLICATIONS

This application is based on Japanese Patent Applications Nos. 2002-190766 and 2002-190958, each content of which being incorporated herein by reference.

### BACKGROUND OF THE INVENTION

1. Field of the Invention

The present invention relates to an image service system which selects one or more images which a user wants to get access to from a plurality of images to effectively supply the desired images to the user. More particularly, the present invention relates to an image distribution system for distributing one or more desired images or information associated with the desired images via network to a user terminal or an image editing system for selecting desired images from a plurality of images to organize the desired images into an electronic photo album.

2. Description of the Related Art

Recently, there has been known an image service system in which a camera is installed, for example, at school, a child care center or a maternity hospital in order to capture one or more images of a child or newborn so that father or relatives can use his or her personal computer at situations remote therefrom to access such images. For example, JP 2002-56079 (A) discloses an image service system in which his or her father or relatives can gain access to images of the baby born in a maternity hospital via a network. JP 2002-125223 (A) discloses a system in which a video camera is installed, for example, in a classroom of a kindergarten or elementary school for distributing time-varying image data to a user terminal so that he or she at home can monitor his or her child's activity.

However, since the former is configured so that information regarding a URL in which many images are stored is transmitted to the user terminal, the subscriber has to access the URL and then select desired ones from many images by himself or herself. The latter is configured so that a streaming video is supplied from a server to a terminal which is connected via a network. Accordingly, a constant connection needs to be established between the server and terminal when the user wants to observe his or her child.

In the meantime, JP 2001-177750 (A) discloses a system in which shots are automatically taken by a monitoring camera installed at school, day care center, amusement park or tourist areas/facilities in order to organize the stored images into an electronic photo album.

However, since the system is designed so that a fixed camera automatically takes shots at a predetermined timing cycle, it is not possible to take shots of a specific person, resulting in a difficult collection of his or her images.

### SUMMARY OF THE INVENTION

In view of above, the object of the present invention is to provide an image service system which selects one or more image which a user wants to get access to from a plurality of images to effectively supply the desired images to the user.

Another object of the present invention is to provide an image service system which relieves a user of the troublesome procedure when the user wants to acquire desired images (e.g., images of his or her child only).

Yet another object of the present invention is to provide an image service system which enables desired images (e.g., images of a user's child only) to be collected with ease.

To achieve the above object, a first aspect of the present invention is an image service system that includes an imaging unit for capturing an image of an object; and a server for storing a plurality of images captured by the imaging unit and selecting one or more desired images from the stored images. The server transmits the selected images or information associated with the selected images via a network to a terminal.

The information associated with the selected images designates information used by a user to gain access to the selected images (e.g., URL in which the selected images are stored). Where the information is transmitted to the terminal, although the user needs to get access to the server, he or she can easily acquire the desired images (e.g., images of his or her child only), which relieves the user of the troublesome procedure of searching for desired images after getting access to the server.

Preferably, the server includes information on a relationship between the object (e.g., a child) and a terminal (e.g., personal computer of the child's parent). In this case, the server selects one from a plurality of terminals to which the selected images or information associated with the selected images are transmitted, based on the information on the relationship and information on the object associated with the selected images.

The information on the object associated with the selected images designates information used to identify an object in an image. For example, where the imaging unit automatically tracks a specific subject to capture an image thereof, the subject in the image is identified. In another case, a subject in an image is identified using an image recognition.

The imaging unit may capture images with regard to a plurality of objects and the server may classify the images captured by the imaging unit into a plurality sets of images per object, so that each classified set of images is selected as the desired images for each object.

The classification of the desired images per object has an advantage that there is a high possibility that images of an object which are to be transmitted to the user terminal associated with the object are ones the user wants to acquire.

The server may include a storage section for storing a plurality of images captured by the imaging unit and a display device for displaying the images stored in the storage section. In this case, the server transmits images selected by an operator from the images displayed on the display device or information associated with the selected images via a network to a terminal.

Herein, the operator is an administrator of the server and different from a terminal user.

With this system, the operator's selection of appropriate images from many images displayed on the display device relives the user of the troublesome procedure of getting access to the system to select desired images by himself or herself.

An additional aspect of the present invention is an image service system that includes an imaging unit for capturing an image in response to a user command transmitted from a user terminal located remote from the imaging unit and/or for automatically tracking one or more specific objects to capture images thereof; and a server for selecting one or more groups of specific images from a plurality of images captured by the imaging unit.

A further aspect of the present invention is an image editing system for creating an electronic photo album, comprising an imaging unit for capturing an image in response to a user command transmitted from a user terminal located remote from the imaging unit and/or for automatically tracking a specific object to capture an image thereof; and a server having a storage section for storing a first group of images captured by the imaging unit. The server selects a second group of images corresponding to a set of specific images (e.g., images of a specific child only) from the first group of images, based on information regarding an object associated with each image of the first group of images.

The system may further include a display device for displaying the first group of images stored in the storage section of the server. The server may further include a second storage section for storing the second group of images, the second group being selected by an operator from the first group of images displayed on the display device.

With this system, the operator's selection of appropriate images (e.g., images of a specific child) from many images displayed on the display device reduces the burden on a successive operator or editor (e.g., minilab operator) who will organize collected images into an electronic photo album per object.

### BRIEF DESCRIPTION OF THE DRAWINGS

These and other objects, advantages and features of the invention will become apparent from the following description thereof taken in conjunction with the accompanying drawings in which:

FIG. 1 is a schematic view of an embodiment of the image service system according to the present invention;

FIG. 2 is a flow chart showing a certification process;

FIG. 3A is a diagram showing a display device screen of a user terminal indicating a main menu window after the certification process is completed;

FIG. 3B is a diagram showing a display device screen of a local server indicating a main menu window after the certification process is completed;

FIG. 4 is a diagram showing a setting window for an administrator of the local server of FIG. 1;

FIG. 5 is a diagram showing the window in FIG. 4 on which a popup window appears for selecting a control mode of the cameras of FIG. 1;

FIG. 6 is a diagram showing the window in FIG. 4 on which a popup window appears for selecting a storage/classification mode;

FIG. 7 is a flow chart showing a shooting sequence of each camera;

FIG. 8 is a flow chart showing a storage/classification sequence of images captured by the cameras of FIG. 1;

FIG. 9 is a diagram showing a window for setting parameters for sending e-mail;

FIG. 10 is a diagram showing the window in FIG. 9 on which a popup window appears for selecting either a manual or automatic operation with which an image to be distributed is selected;

FIG. 11 is a diagram showing the window in FIG. 9 on which a popup window appears for selecting either a manual or automatic operation with which an address of a terminal to which an image is to be distributed is selected;

FIG. 12 is a diagram showing the window in FIG. 9 on which a popup window appears for setting a time parameter indicating when e-mail is to be sent; and

FIG. 13 is a diagram showing a window for creating an electronic photo album.

### DETAILED DESCRIPTION OF THE PREFERRED EMBODIMENTS

With reference to the drawings, a preferred embodiment of the present invention will be described hereinafter. While of broader applicability, the present invention will be described in connection with children and parents.

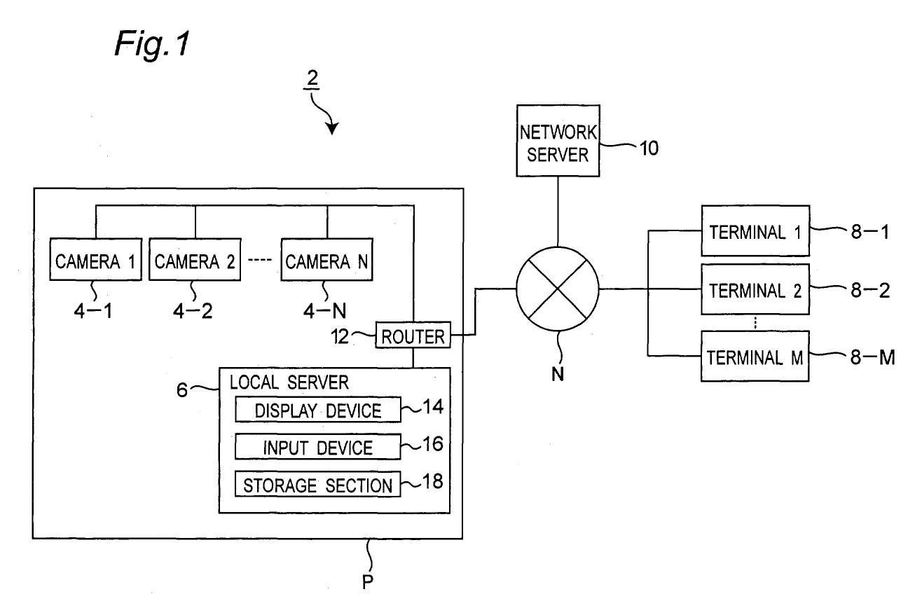

Referring now to FIG. 1, an image service system (image distribution system, image editing system) of an embodiment according to the present invention, generally indicated at reference number 2, includes one or more cameras 4(4-1 to 4-N) (which constitute an imaging unit) and a local server 6, both of which are installed in a child care center, school or other supplier of child care services P (hereinafter referred to as child care center) The system 2 also includes a plurality of user computers or terminals 8(8-1 to 8-M) and a network server 10. The local server 6 is connected via a router 12 provided in the child care center P to each camera 4. The user terminals 8 and network server 10 are connected via Internet N to the router 12.

Each camera 4 is a pan, tilt and zoom camera, which can be controlled and take a shot of an object by a command from a user terminal 8 located remote therefrom or a command from the local server 6. Herein, the term “shot” designates an image which is captured by the camera 4 and is then stored in a storage section (described below) of the local server 6. Typically, the system 2 has a plurality of cameras 4, so that one or more cameras are located in each site such as classroom or playground.

The local server 6 is a computer system, which can be accessed by an administrator (operator) such as nurse and includes a display device 14 and an input device 16 such as keyboard. The local server 6 incorporates a computer program for sending e-mail and creating an electronic photo album or digital photo album, which will be described below, and includes a storage section 18 for storing images captured by the cameras 4. The computer program may be incorporated on a computer-readable recording medium. The network server 10 is a computer system for performing, for example, a certificate operation when one of the user terminals 8-1 to 8-M requests a connection with the local server 6 and/or one of the cameras 4.

The terminal 8 may be a cellular phone, PC (personal computer) or PDA (personal data assistant). A user command via the terminal 8 for controlling one of the cameras 4-1 to 4-N is carried out by communicating between the camera 4 and terminal 8 after the connection between the terminal 8 and network server 10 via Internet N is completed.

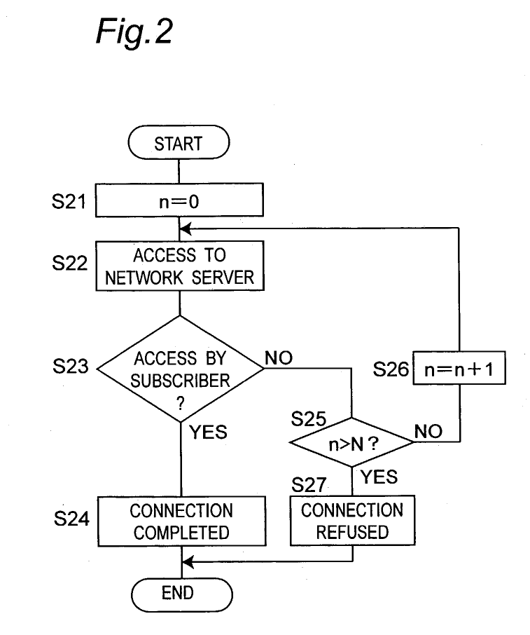

FIG. 2 shows a flow chart showing a procedure for connecting one of the user terminals 8-1 to 8-M with the network server 10. First, at step 21, an index n is set to be 0. At step 22, the user terminal 8 gets access to the network server 10. At step 23, the network server 10 determines whether a subscriber tries to access it or not based on a user's ID and password. If the determination is affirmative, a connection is completed between the user terminal 8 and network server 10 (step 24). If the determination is negative, the procedure moves to step 25. At step 25, if the index n is equal to or less than a predetermined value N, the procedure moves to step 26 so that the index n is incremented by one and then returns to step 22. At step 25, if the index n is more than N, i.e., the user is not identified more than a predetermined number of times, the network server 10 refuses the connection from the user terminal 8 and transmits a message to the user terminal 8 telling that the connection has been refused (step 27).

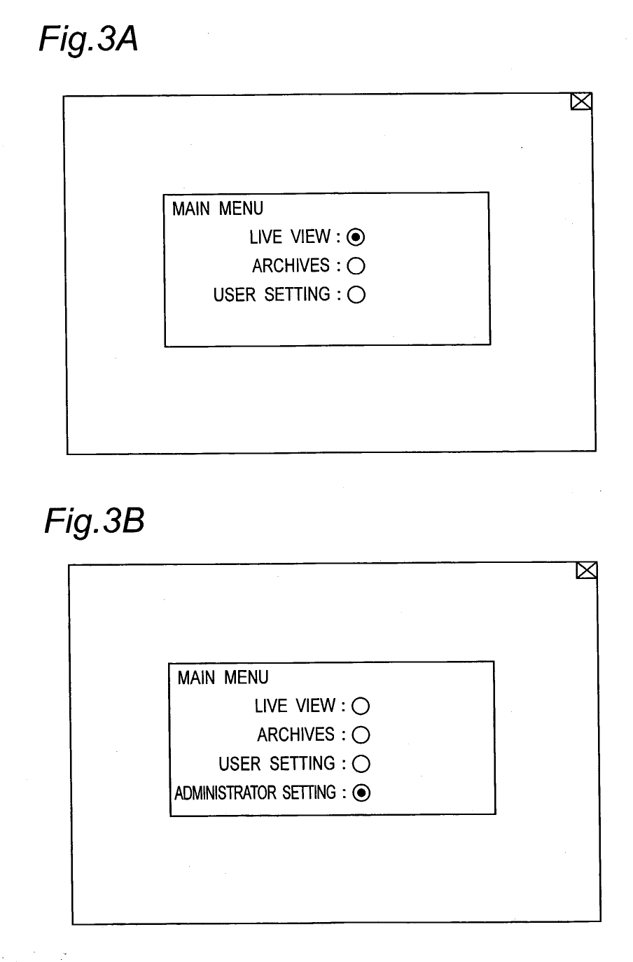

FIG. 3A shows a main menu window on a display device screen of the user terminal 8 after the connection with the network server 10 has been completed. The window provides plural menus available to the user such as “Live View”, “Archives” or “User Setting”.

In the “Live View” menu, the user can view a live activity captured by one or more cameras 4 in real time via his or her terminal 8. The user can also control one of the cameras 4-1 to 4-N by inputting a pan, tilt, zoom and/or shot command via his or her terminal 8. The system 2 is designed so that each user has to gain a “control right” before he or she controls one of the cameras 4-1 to 4-N over a predetermined period of time because there might be the case where more than one users select the “Live View” menu at the same time.

In the “Archives” menu, the user can view pre-recorded activity or images stored in the local server 6.

The “User Setting” menu gives an option of changing current settings such as password, address or type of image to be distributed. The “User Setting” menu provides plural menus such as “Password Change, “Address Change” or “Type of Image”. In the “Password Change” menu, a user can change a password which the network server 10 uses to identify the user. In the “Address Change” menu, a user can change an address of a terminal 8 to which image data stored in the local server 6 is transmitted. In the “Type of Image” menu, a user can select a type of image (either time-varying image or still image) so that only the selected type of image stored in the storage section 18 of the local server 6 is distributed. The distribution of image data will be described in greater detail.

In the embodiment, the network server 10 also identifies an operator when the person tries to access the local server 6. Once the connection has been completed, a main menu window is displayed on a screen of the display device 14 of the local server 6, providing an “Administrator Setting” menu, which will be described below, in addition to the “Live View”, “Archives” and “User Setting” menus, as shown in FIG. 3B. The “User Setting” menu provides a “Camera Setting” menu only for the administrator or operator.

In the “Camera Setting” menu, the operator changes various settings for each camera 4 such as trigger generation condition or circuit order described below.

The trigger generation condition designates a condition under which a trigger signal is generated. The trigger signal is used to cause an image to be captured by at least one of the cameras 4-1 to 4-N for the storage in the storage section 18. The trigger may include time, moving body, illumination or outside triggers. The time trigger signal is generated at a specified time. A selection of one or more times of day (e.g., lunchtime) allows a children's activity to be recorded on a regular basis. The moving body trigger signal is generated when a moving body is detected in an area to be monitored by one of the cameras 4-1 to 4-N. The illumination trigger signal is generated when a light intensity varies beyond a predetermined value. The outside trigger signal is generated when an infra-red sensor or tactile sensor generates a detection signal. The tactile sensor is implanted in, for example, a stuffed animal to transmit a detection signal when a child touches the stuffed animal, so that at least one of the cameras 4-1 to 4-N is controlled to view the animal at the center of its view field, allowing an image of the child to be captured. The outside trigger may be a sound sensor which recognizes a voice of a specified child. In this case, by configuring the sound sensor so that a voice of joy causes a trigger signal to generate, it might be possible to take a shot of the child when he or she behaves in a more natural way.

An image may be stored in one of several ways, which can be selected by an administrator: When a trigger signal is generated, a still image may be captured and stored in the storage section 18. A time-varying image for several seconds before and after a trigger signal is generated may be captured and stored in the storage section 18. For this purpose, instead of taking a shot in response to a trigger signal or a user's shot command, the camera 4 may capture image time-series data in response to a synchronizing signal from the local server 6 and the data may be temporarily stored in a memory (not shown) in the local server 6.

The administrator can select a fixed mode in which each camera 4 views one area within its field of view or a circuit mode in which each camera 4 makes a circuit of and views a plurality of areas within its field of view. The circuit order designates an order in which each camera 4 makes a circuit of the areas to be monitored.

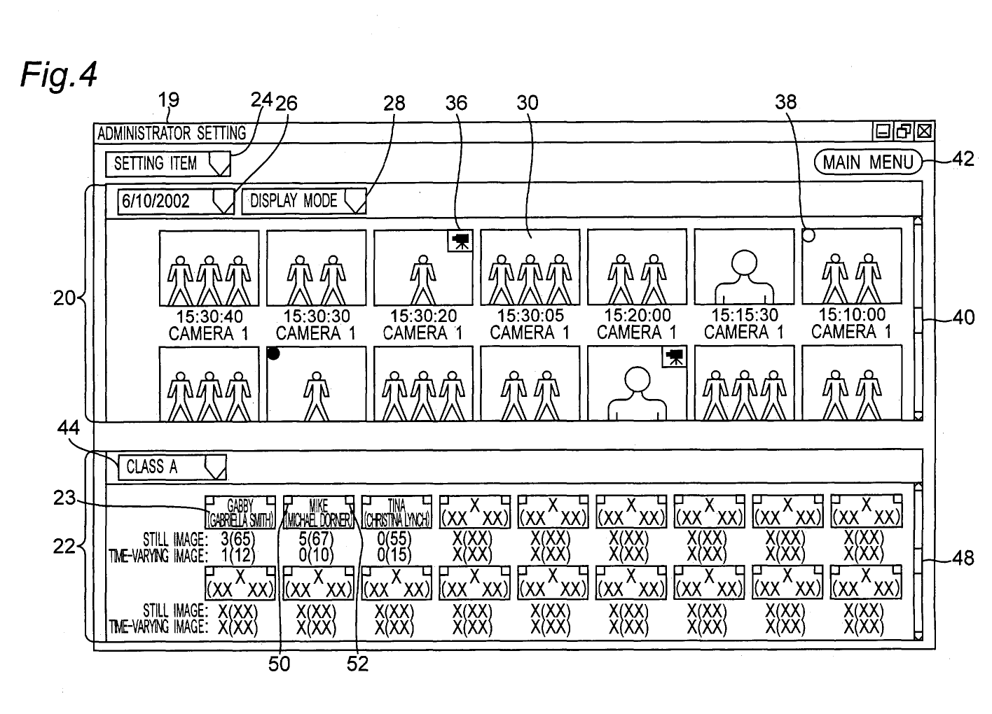

When the administrator selects the “Administrator Setting” menu (FIG. 3B), a setting window 19 for the administrator shown in FIG. 4 is displayed on the display device 14 of the local server 6. An area 20 for unclassified images is located on an upper side of the window 19. The non-classification area 20 contains images which have not yet been classified per child or images of children. An area 22 for classified images is located on a lower side of the window 19. The classification area 22 contains individual folders 23 each including images per child. A “Setting Item” 24 is located above the non-classification area 20.

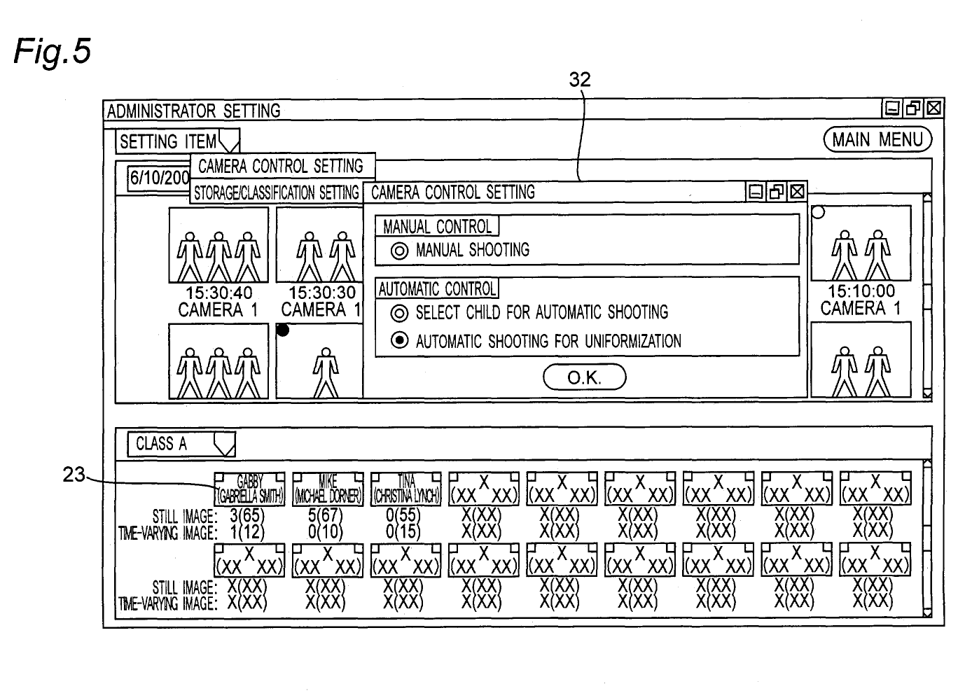

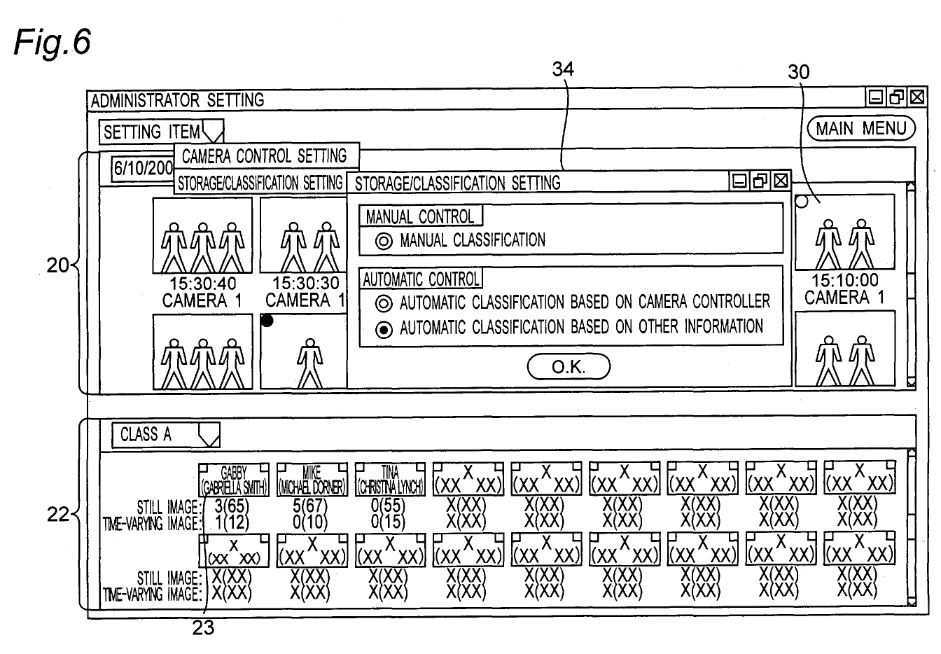

The non-classification area 20 includes a date selection area 26, “Display Mode” 28 and unclassified thumbnail images 30. A click of the “Setting Item” 24 causes a pop-up window (see FIGS. 5 and 6) to appear on the display screen, providing “Camera Control Setting” and “Storage/Classification Setting” menus. A selection of the “Camera Control Setting” menu causes a setting window 32 shown in FIG. 5 to appear on the display screen. A selection of the “Storage/Classification Setting” menu causes a setting window 34 shown in FIG. 6 to appear on the display screen. These setting menus will be described hereinafter.

Referring back to FIG. 4, the date selection area 26 is used to select a date (e.g., by the day, by the week, by the month or by the year) so that thumbnail images 30 taken under the date are displayed.

A click of the “Display Mode” 28 causes a “Display Mode” menu window (not shown) to appear on the display screen for selecting one of plural modes in each of which thumbnail images 30 are displayed, for example, per tag (described below), per trigger, per camera or per time period (e.g., per hour). The thumbnail images 30 may be displayed in a way selected in the “Display Mode” menu and also arranged in an order in which images were taken. For example, latest images may be located on an upper side or lower side of the non-classification area 20. The change of the content displayed on the non-classification area 20 has an advantage that the administrator can easily classify images. For example, when the administrator tries to classify images of a child, there is a high possibility that images taken in the child's classroom contain many images of the child. Accordingly, thumbnail images displayed per camera enables the administrator to easily find images of the child to be classified.

In the embodiment, the thumbnail images 30 contain still images and time-varying images. A mark 36 indicative of motion picture is displayed on an upper right side of each thumbnail 30 of a time-varying image. Where the administrator or user controlled the camera 4 to take a shot, a thumbnail image for motion picture may be an image frame which was initially captured. Where a time-varying image captured by at least one of the cameras 4-1 to 4-N is stored in the storage section 18 in response to a trigger, a thumbnail image may be an image frame when a trigger signal was generated, although an image for several seconds before and after the signal was generated is stored, as described above.

A date/time when an image was taken and the associated camera 4 are displayed below the corresponding thumbnail image 30. In case of a still image, the date/time indicates when it was captured. In case of a time-varying image, the date/time indicates when an initial image frame was captured except that, where a time-varying image is stored in the storage section 18 in response to a trigger, it indicates when a trigger signal was generated. Where information on each thumbnail image 30 other than on the date/time or camera has been added, a tag 38 is displayed on an upper left side of the thumbnail image 30. The tag 38 may be displayed in a different color depending on the additional information so that the kind of tag 38 can be easily verified.

A click on the tag 38 of the thumbnail image 30 causes a pop-up balloon (not shown) displaying some information to appear on the display screen. Such information may include an orientation (pan/tilt angles) and magnification of the camera when the image was taken, a person who controlled the camera to take a shot, trigger name where the image was taken in response to a trigger, a subject name where the camera automatically tracks to capture the person, which will be described hereinafter. As tag information, some comments may be typed in in the pop-up balloon by the administrator. The comments may be inputted via keyboard or selected from a set of prepared lists. Alternatively or in addition, comments may be inputted by handwriting using, for example, a pen tablet, in case where the administrator is not used to handling a keyboard.

It is noted that reference number 40 indicates a scroll bar over which a cursor (not shown) is placed and moved in a vertical direction so that the non-classification area 20 is scrolled up and down. Reference number 42 indicates a button to be clicked on to move back to the main menu window.

The content of the classification area 22 will now be described in greater detail. An area 44 is used to select a class name where there are more than one classes in the child care center. The selection of a class allows the administrator to easily classify images with a manual operation, which will be described hereinafter. As set forth above, the classification area 22 includes the individual folders 23. A nickname and/or full name of a child is displayed on each individual folder 23. Alternatively or in addition, a typical image of a child or latest renewable image may be displayed. Numbers below each individual folder 23 indicate numbers of still images and time-varying images which have been taken for a day. The numbers in a bracket indicate numbers of still images and time-varying images which have been taken until now. The individual folder 23 is associated with information on a relationship between the child and the parent or user (and terminal 8). A click on each individual folder 23 causes a window (not shown) to appear on the display device 14 of the local server 6. Stored thumbnail images are displayed on the window. It is noted that reference number 48 indicates a scroll bar over which a cursor (not shown) is placed and moved in a vertical direction so that the classification area 22 is scrolled up and down.

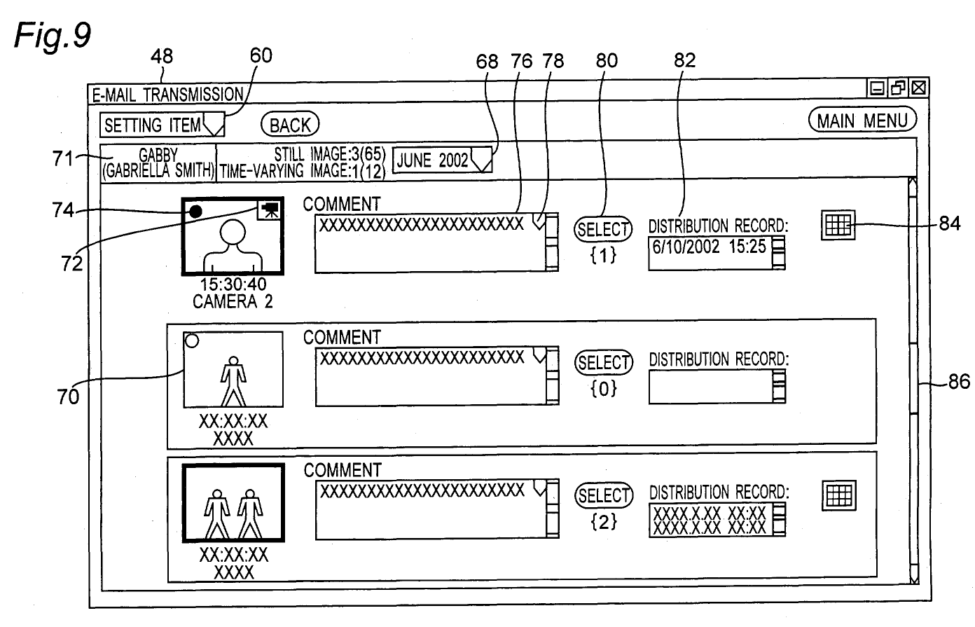

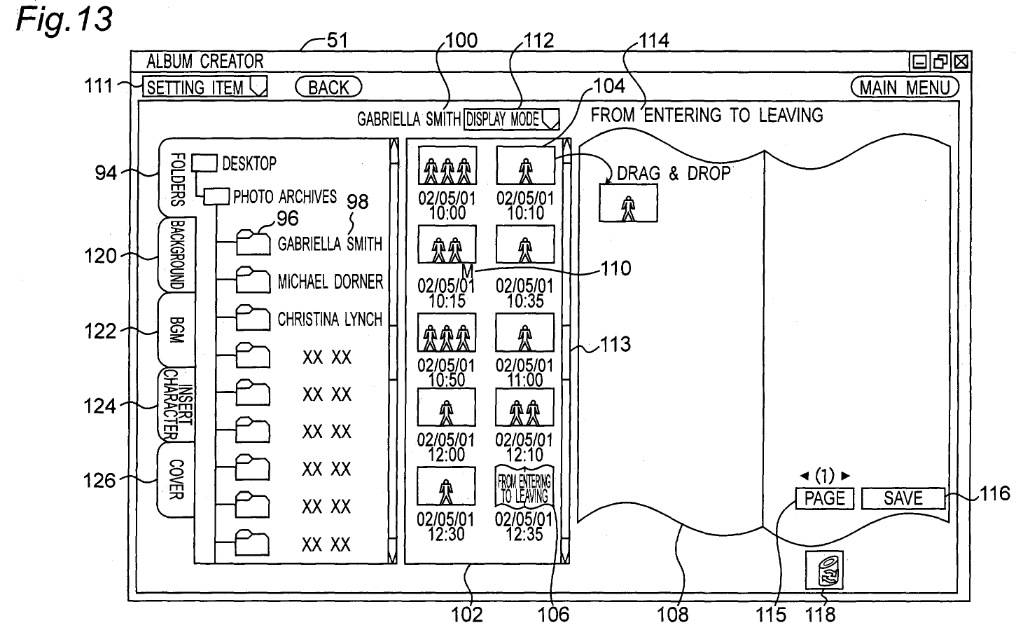

On each individual folder 23 are provided a button 50 for switching the display screen from the window 19 to a window 48 (FIG. 9) for setting parameters for sending or transmitting e-mail and a button 52 for switching the display screen from the window 19 to a window 51 (FIG. 13) for creating an electronic photo album.

The e-mail transmission designates a transmission of e-mail to one of the user terminals 8-1 to 8-M, to which desired images or only information associated with images (e.g., a URL in which desired images are stored) are attached. The desired images are ones that a user might be interested in (e.g., images of the parent's son or daughter) selected from images which have been stored using the image service system 2. Some musical data that might go well with the desired images may also be transmitted together with the images.

The creation of an electronic photo album designates a collection of images (for example, images of a child taken for a month, for a year or for a period of time from entering to leaving the day care center) from images, which have been captured and stored using the image service system 2, to organize them into an electronic photo album. Herein, the term “album” designates a set of images selected from stored images. The transmission of e-mail and the creation of the electronic photo album will be described in greater detail.

Referring to FIG. 5, a selection of the “Camera Control Setting” in the “Setting Item” 24 causes the setting window 32 to appear on the display screen. The administrator can select either a manual control mode or automatic control mode. The manual control designates a pan, tilt, zoom and/or shot operation of one of the cameras 4 that is performed in response to a command from the administrator or user (child's parent) who watches a live view. This enables the administrator or user to take an image of a desired composition. The automatic control designates an automatic pan, tilt, zoom and/or shot operation of one or more of the cameras 4. In this case, the administrator can further select either a mode in which images of a specified child are taken or a mode in which images of a child are taken, where the number of images of the child was relatively small. In the former mode, a child is specified, for example, by selecting the individual folder 23 of the child by the administrator. In the latter mode, the local server 6 calculates a number of images associated with the individual folders 23 (number of shots taken for a day or number of shots takes until now) stored in the storage section 18 to detect a child whose number of shots was relatively small. The number may be that of still images, time-varying images or a combination thereof. The camera(s) 4 track and take a shot of the child depending on the number. This mode has an advantage that numbers of shots per child can be uniformized. The method in which the camera(s) 4 are controlled to automatically perform a pan, tilt and/or zoom operation to track a specific child may be 1) an image recognition of a child's physical character (e.g., face or retina) or name card attached to clothes of the child, 2) detection of a color of clothes of the child, or 3) a signal reception from a transmitter, the signal being indicative of an identification of the child who carries it or who wears clothes having a name card or shoes in which the transmitter is implanted.

The system 2 may be designed so that an annual schedule can be stored so that in an event such as birthday party of a child the camera(s) 4 can automatically capture many images of the child to store them in the storage section 18. Where the administrator tries to create an album of the event, since adequate images have been collected, he or she can easily do it.

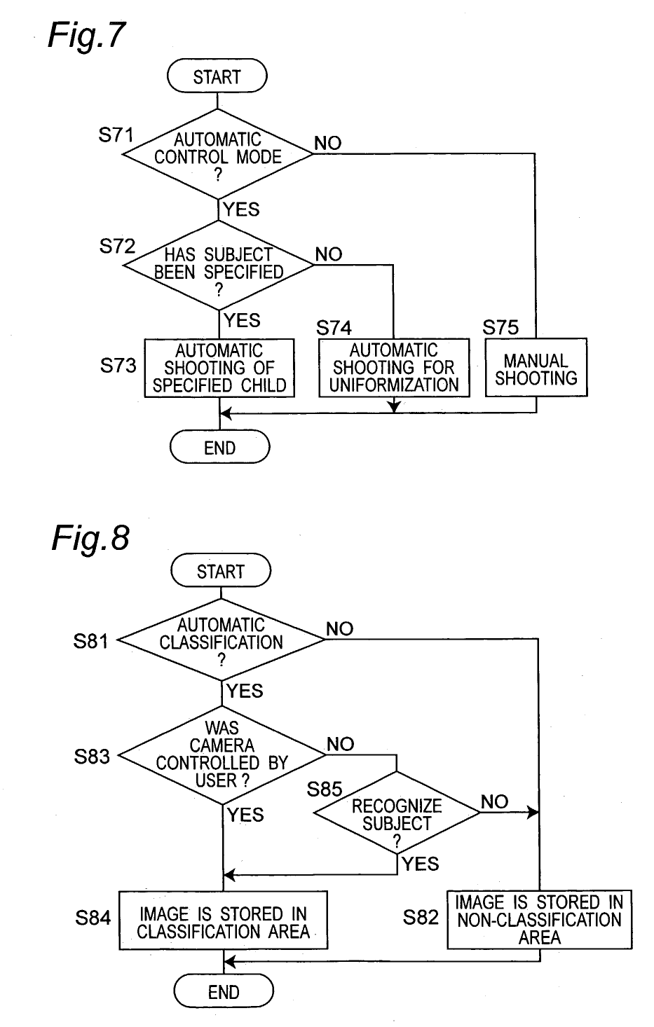

A shooting sequence of each camera will be described with reference to FIG. 7. At step 71, a determination is made as to whether an automatic control mode is selected. If the determination is affirmative, the process moves to step 72 in which a determination is made as to whether a child has been specified as subject by the administrator. If the determination is affirmative, the camera 4 automatically performs a pan, tilt, zoom and shot operation to track and take an image of the specified child. If the determination is negative at step 72, the process moves to step 74 in which the camera automatically performs a pan, tilt, zoom and shot operation to track a child whose number of shots are small and take image(s) of the child. If the determination is negative at step 71, the process moves to step 75 in which the camera waits for a command from the administrator or user (parent) before it takes a shot of a child.

Regardless of the control mode that the administrator have selected, the camera 4 may be controlled to perform a pan, tilt, zoom and shot operation when a parent or user with a “control right”, watching a live view of the child, inputs a command via the user terminal 8. Although a user with the “control right” has the right to control one of the cameras 4 to take a shot of the child, there might be the case that the user views a live view without inputting a shot command. In this case, the camera may be controlled to take a shot of the child at an appropriate time even if it does not receive a shot command from the user. Since there might be the case that it takes some time for a user with the control right to control one of the cameras 4-1 to 4-N to find the child, the camera 4 may automatically take an image of the child after a predetermined period of time has elapsed. If the camera 4 has not been controlled to perform a pan, tilt and zoom operation during a period of time, there might be a high possibility that the user finds his or her child and views the activity. In this case, the camera may automatically take a shot of the child after a predetermined period of time has elapsed.

Referring to FIG. 6, a selection of the “Storage/Classification Setting” in the “Setting Item” 24 causes the setting window 34 to appear on the display screen. The Thumbnail images 30 in the non-classification area 20 can be classified into the individual folders 23 in the classification area 22 either with a manual operation or automatic operation, which can be selected by the administrator. In the manual classification mode, the administrator selects each thumbnail image 30 in the non-classification area 20 on the window 19 and then drag-and-drops it into its corresponding individual folder 23. In the automatic classification mode, the administrator can further select either a mode in which images are classified based on information as to who has controlled the camera 4 or a mode in which images are classified based on other information for recognition. In the former mode, images taken while a user or parent controlled the camera 4 are classified into the individual folder 23 of the parent's child. In the latter mode, an image recognition of a child's physical character (e.g., face or retina) or name card attached to clothes of a child or a recognition of a color of clothes of a child causes the thumbnail images 30 to be automatically stored in the individual folder 23 which corresponds to the recognized child. Where the camera 4 performs an automatic pan, tilt, zoom and shot operation to track and take shots of a subject, they may be automatically stored in the individual folder 23 based on a name of the subject.

Where the automatic classification mode is selected, although most of the images are directly stored in the individual folders 23 without being temporally stored in the non-classification area 20, images that are impossible to automatically classify are stored in the non-classification area 20. The thumbnail images 30 of these unclassified images can be manually selected by the administrator and restored in the individual folders 23 with a drag-and-drop operation.

An image of children may be stored in more than one individual folders 23. An image which has been classified into an inappropriate individual folder 23 in the automatic classification may be returned back to the non-classification area 20 with a manual operation.

A storage/classification sequence of images will be described with reference to FIG. 8. At step 81, the local sever 6 verifies either the automatic mode or manual classification mode has been selected. If the manual classification mode has been selected, images which were captured are stored in the non-classification area 20 at step 82. The administrator will then move the thumbnail images 30 to the individual folders 23 with a manual operation. If the automatic classification mode has been selected at step 81, the local server 6 determines whether an image is one that was taken while a parent or user controlled the camera 4 at step 83. If the determination is affirmative, the image is stored in the individual folder 23 of the parent's child at step 84. As set forth above, shots taken while a parent controlled the camera 4 include 1) images taken by the camera 4 in response to a shot command from the parent with the “control right” watching a live view and 2) images automatically taken by the camera 4 in response to a shot command from the local server 6 of the system 2 in case where the camera has not been controlled to perform a shot operation although the parent with the “control right” watched a live view. An image taken by a user can be classified into the individual folder 23 of his or her child because the parent has been identified when getting access to the network server 10 and the individual folder 23 is associated with information on a relationship between the parent and child.

If the determination is negative at step 83, i.e., a shot is not one that was taken while a parent controlled the camera 4, the process moves to step 85 in which the local server 6 determines whether it is possible to recognize a subject in the image (using a method such as image recognition, color recognition or recognition of a subject's name in case of the automatic tracking/capturing operation). If the determination is affirmative, the process moves to step 84 in which the shot is stored in the corresponding individual folder 23. If the determination is negative, the process moves to step 82 in which the shot is stored in the non-classification area 20.

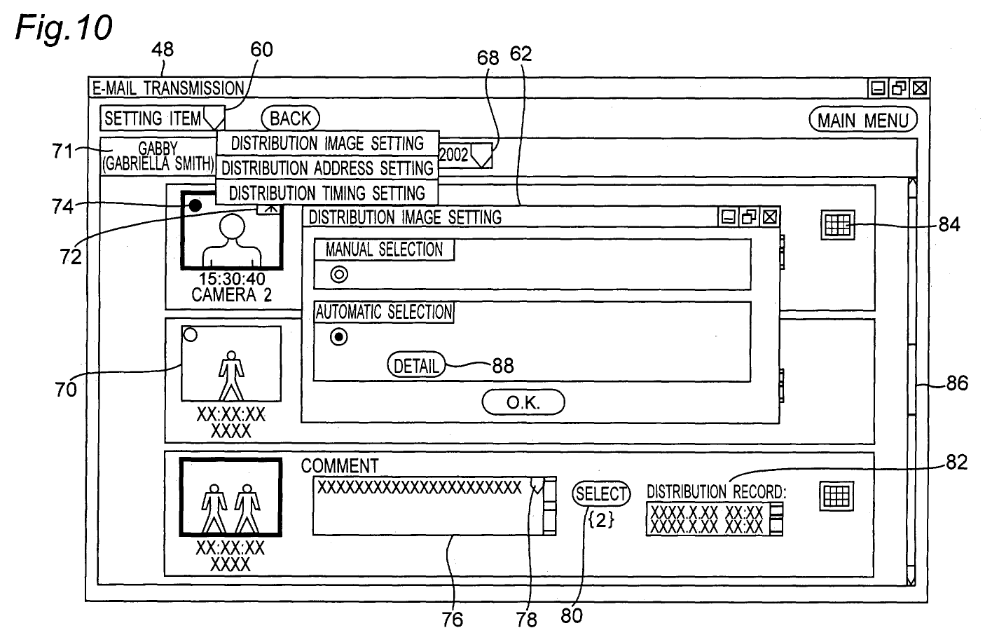

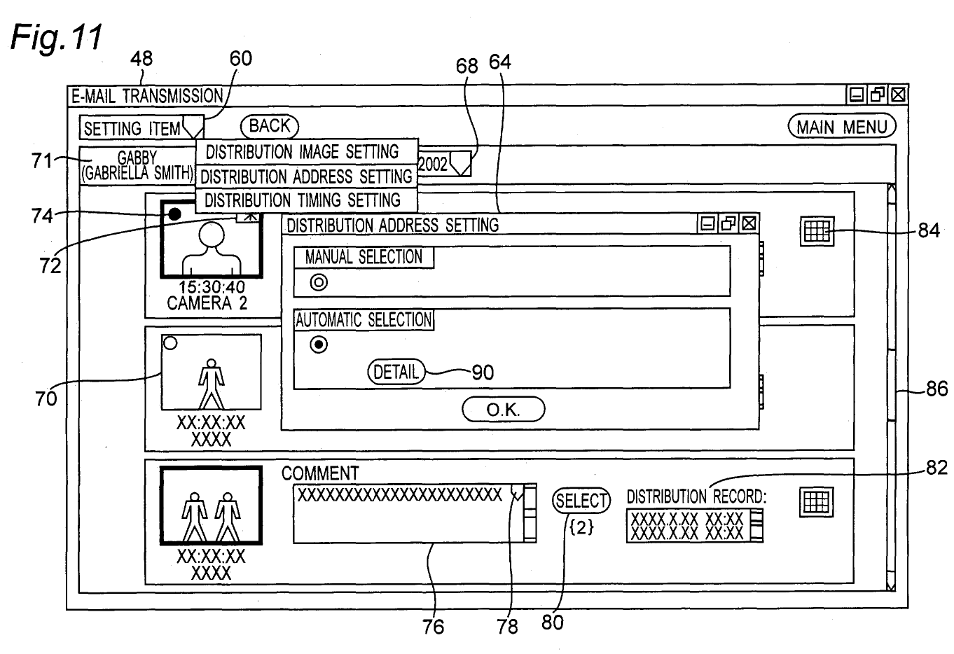

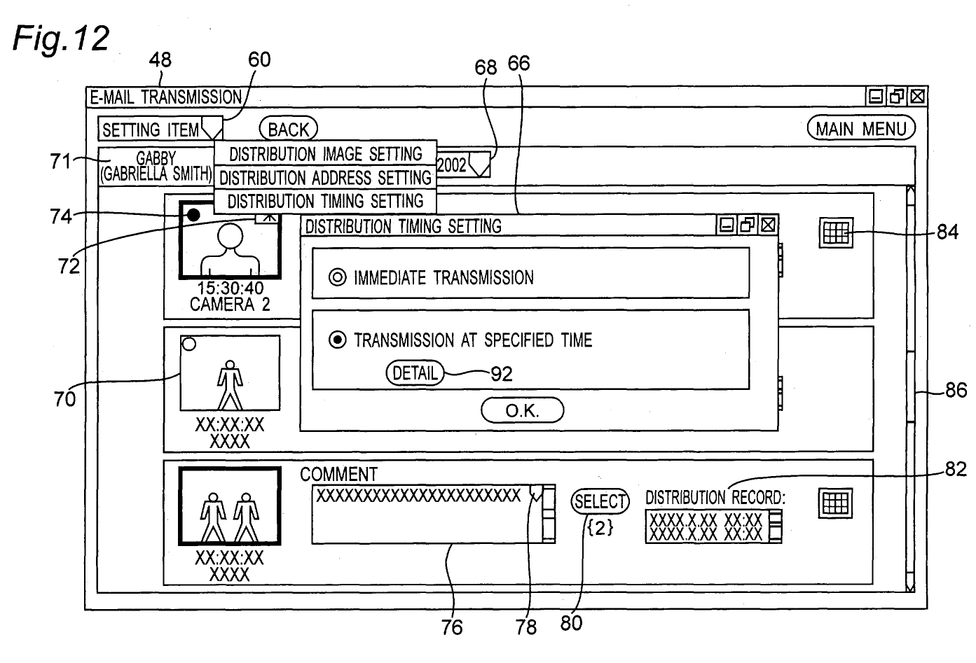

Referring now to FIG. 9, the window 48 for setting parameters for sending e-mail to the user terminals 8-1 to 8-M will be described. A click of a “Setting Item” 60 causes a pop-up window (see FIGS. 10-12) to appear on the display screen, providing “Distribution Image Setting”, “Distribution Address Setting” and “Distribution Timing Setting” menus. A selection of the “Distribution Image Setting” menu causes a window 62 as shown in FIG. 10 to appear on the display screen. A selection of the “Distribution Address Setting” menu causes a window 64 as shown in FIG. 11 to appear on the display screen. A selection of the “Distribution Timing Setting” menu causes a window 66 as shown in FIG. 12 to appear on the display screen. Although in the embodiment the parameters set in the “Setting Item” 60 are applied to all the individual folders 23, such parameters may be specified per individual folder 23. The parameter setting by means of the windows 62, 64 and 66 will be described hereinafter.

A “date” 68 is used to select a date (e.g., by the day, by the week, by the month or by the year) so that thumbnail images 70 under the date are displayed.

An area 71 is used to display information (e.g., name) regarding the individual folder 23. This allows the administrator to easily recognize the individual folder 23, the content of which is currently displayed on the screen. Like the setting window 19 (FIG. 4) for the administrator, the number of images stored in the individual folder 23 is displayed.

Also, like the setting window 19 (FIG. 4) for the administrator, a mark 72 indicative of motion picture and a tag 74 are displayed on an upper right side and upper left side of each thumbnail image 70, respectively. A date/time when an image was taken and the associated camera 4 are displayed below the corresponding thumbnail image 70. The tag information may include information indicating that the image has been classified into the individual folder 23. It also may include information indicating that e-mail has been sent to the user terminal 8 and/or the image has been used to create an album.

Where e-mail to which an image or information on the image is attached has been sent to the user terminal 8, the thumbnail image 70 of the image may be boxed as shown in FIG. 9. This enables the administrator to easily find that e-mail transmission is completed.

A “comment” area 76 is used to type in comments such as text or subject of e-mail. They may be inputted via keyboard or selected from list 78 in which a set of prepared lists or lists drawn up by the administrator are contained. The list 78 may contain comments which were typed in in the comment area 76. The comments may be typed in by handwriting with, for example, a pen tablet. An image on which a comment was superimposed may be attached to e-mail.

A “Select” 80 is a button to be clicked on when the administrator manually selects an image to be distributed. The number below the “Select” button 80 indicates how many times each image has been distributed.

A “Distribution Record” 82 shows the time when the image was distributed. A mark 84 indicates that the image has been used to create an electronic photo album.

A scroll bar 86 is used to scroll up and down the display screen.

Referring to FIG. 10, a selection of the “Distribution Image Setting” menu in the “Setting Item” 60 causes the setting window 62 to appear on the display screen, which enables the administrator to determine whether an image to be transmitted to the user terminal 8 is manually (by himself or herself) or automatically selected. In the manual selection mode, an image to be distributed (which is herein referred to as distribution image) is selected by clicking on the “Select” button 80 (see FIG. 9) on the window 48. In the automatic selection mode, the local server 6 selects a distribution image based on the tag 74 associated with the image. For example, based on the information of the tag 74 indicating whether each image has been distributed, the local server 6 selects an image which has not yet been distributed rather than an image which has been distributed once.

In addition, a click on a “Detail” button 88 on the window 62 causes the information of the image to be automatically selected (e.g., date/time when the image was taken, person who controlled the camera 4 to take a shot or trigger name) to be displayed (not shown). This enables the administrator to configure the local sever 6 so that it automatically selects only specific images (e.g., images taken in response to an outside trigger only).

Referring to FIG. 11, a selection of the “Distribution Address Setting” menu in the “Setting Item” 60 causes the setting window 64 to appear on the display screen, which enables the administrator to determine whether an address to which an image is transmitted (which is herein referred to as distribution address) is set manually (by himself or herself) or automatically. In the manual selection mode, an address is typed in or selected from a list of addresses by the administrator. A selection of the manual selection mode causes a window (not shown) on which an address can be typed in to appear on the display screen. In the automatic selection mode, based on the information on a relationship between the child and parent, the local server 6 sets an address which the parent has registered to be a distribution address.

In addition, a click on a “Detail” button 90 on the window 64 allows a distribution address to be set in fine detail. For example, the administrator can configure the local server 6 so that it sets all the registered addresses to be a distribution address (nowadays, each user may have more than one terminals) or sets some of the registered addresses to be a distribution address depending on a type of image (time-varying or still image). For example, a cellular phone may not receive a time-varying image.

Referring to FIG. 12, a selection of the “Distribution Timing Setting” menu in the “Setting Item” 60 causes the setting window 66 to appear on the display screen, which enables the administrator to determine whether e-mail is sent to the user terminal 8 “immediately” or at a specified time. Where the administrator selects an immediate transmission, immediately after a distribution image was selected and a distribution address was set, e-mail is sent to the user terminal 8. Where the administrator selects a transmission at a specified time, e-mail is not sent at a time when a distribution image was selected and a distribution address was set. A set of distribution images are distributed at a specified time or at fixed intervals. The time or intervals can be specified by means of a window (not shown) which appears by clicking on a “Detail” button 92.

Where a number of users or parents watch a live view or view images stored in the local server 6 during a lunch break in the office, a load on the local server 6 might become heavier or a channel between the local server 6 in the child care center P and Internet N might be congested. The setting of the distribution timing can prevent images from being distributed during such a time slot.

Referring now to FIG. 13, the window 51 for creating an electronic photo album will be described. A list of individual folders 96 in each of which images of a child are stored are displayed in an area 94. The images stored in one of the individual folders 96 are identical to those stored in the corresponding individual folder 23 on the setting window 19 for the administrator (FIG. 4). One or more individual folders 96 may contain a set of images taken in event(s). When an administrator (e.g., nurse) specifies one of the folders 96 or folder names 98, the name 98 is displayed in an area 100. Also, a list of thumbnail images 104 of still and/or time-varying images stored in the folder 96 and/or an album file 106 are displayed in an area 102. The album file 106 is a file in which an album which is being made or has already been made for each child is stored. A click on the album file 106 causes the content of the album to be displayed in an editor area 108. A date/time when each image was captured is displayed below the corresponding thumbnail image 104. In order to distinguish between still and time-varying images, an “M” mark 110 is displayed on the thumbnail image 104 of the time-varying image. Such distinction may be made by colorizing the thumbnail images 104. A “Setting Item” 111 is used for the administrator to select a manual mode in which he or she moves each of the thumbnail images 104 on the area 102 to the editor area 108 by himself or herself or an automatic mode in which local server 6 performs an automatic drag-and-drop operation based on predetermined information. The automatic mode will be described hereinafter.

The thumbnail images 104 and album file 106 in the area 102 can be displayed in a way selected in a “Display Mode” 112. They can be displayed, for example, per tag which is associated with each image (e.g., trigger information), per month, per season (spring, summer, fall and winter). The display per month or per season facilitates a seasonal creation of an electronic photo album. The thumbnail images 104 and album file 106 in the area 102 can be displayed in time series as well as in a way selected in the “Display Mode” 112. The arrangement of the thumbnail images 104 in an order in which images were taken has an advantage that in the manual mode the administrator can easily arrange the thumbnail images 104 on the editor area 108 in time series. A scroll bar 113 is used to scroll up and down the area 102.

The editor area 108 enables the administrator to flip through pages displayed thereon. The administrator can drag each of the thumbnail images 104 in the area 102 and then drop in the editor area 108 in order to display the thumbnail image 104 on the editor area 108. The thumbnail image 104 dropped in the editor area 108 may be displayed in a fixed zone or a zone specified by the administrator. A magnified image may be displayed instead of a thumbnail image. The local server 6 may be designed to recognize faces and/or number of persons in an image based on the image data of the thumbnail image 104 which is being dragged, so that the corresponding image displayed on the editor area 108 is enlarged. For example, by counting the number of persons in an image, the local server 6 may determine whether the number is more than a predetermined value. If the determination is affirmative (i.e., the image is identified as a gathering image), the image is magnified on the editor area 108.

An area 114 is used to display and/or change an album's name. A title may be given to each page. A “Page” 115 displays a current page number of the album. A click on marks by the administrator on a left side or right side of the page number causes a page to be changed. A click on a “Save” 116 causes an album which is being created to be saved in the area 102. The name of the album and time when it has been saved is displayed on and below the album file 106, respectively. A “Trash” icon 118 is used to delete an unnecessary image. For this purpose, an unnecessary image displayed in the areas 102 or 108 may be specified and then the “Trash” 118 may be clicked. Alternatively, an unnecessary image may be dragged and then dropped in the “Trash” 118.

A set of tabs 120, 122, 124 and 126 are used to decorate the album. A selection of the “Background” 120 causes a pop-up window (not shown) on which various templates for the album background (e.g., floral or landscape) are displayed to appear on the display screen. A subsequent selection of one of the templates causes it to be displayed as background of the editor area 108. A selection of the “BGM” 122 causes a pop-up window (not shown) on which a list of BGMs (musical data) is displayed to appear on the display screen. A subsequent selection of one of the BGMs causes the music to be played on. If desired, the BGM data can be attached to the album. Preferably, the local server 6 is designed so that a seasonal illustration (e.g., cherry blossom for spring) may be inserted as background or a seasonal BGM may be attached to the album. The “Insert Character” 124 is used to type in a character or letter in the album. A selection of the “Insert Character” 124 causes a pop-up window (not shown) on which various templates such as pop-up balloon are displayed to appear on the display screen. The window enables the administrator to specify a desired location in the editor area 108 in which a pop-up balloon is inserted. An input device such as keyboard, pen tablet or voice input device may be used to type in a comment in the pop-up balloon. A comment may be directly typed in a desired location in the editor area 108. A color, size or type face of a character to be inserted may be selected. Information associated with each image (e.g., information on date/time or location) may be used as comment for the image. A “Cover” 126 is used to select a cover of the album. A selection of the “Cover” 126 causes a pop-up window (not shown) on which various templates for an album cover are displayed to appear on the display screen, allowing the administrator to select one of them. A character may be inserted in the selected cover.

The “Background”, “BGM” and “Insert Character” may be provided for each page of the album. However, a setting of these items for the first page to be compiled may automatically result in the same layout for the rest of the pages.

As described above, a selection of an automatic creation in the “Setting Item” 111 causes the local server 6 to automatically compile an electronic album based on predetermined information. As predetermined information, information associated with each image may be used so that an image is automatically selected for creating an album based on the information. The information may include information given when the image was taken (for example, a date/time or a trigger name where it was taken in response to the trigger) or information which has been given by the administrator or system 2 after the image had been taken. For example, an album background or BGM per season may be given based on the date/time information, so that an album with music can be automatically created. Where an annual schedule can be set as described above, an album of an event can be automatically created by associating each image with the event information. For example, in case of a birthday party, each image associated with information indicating that it was taken in the party is automatically selected and used for an automatic creation of an album for the birthday party. Also, a template for a birthday party may be automatically selected as album background. Further, a song (e.g., Happy Birthday to You) may be automatically selected as album BGM.

The image selected for sending e-mail to which the image or information on the image has been attached may be automatically selected and used to create an album.

Where an album is automatically created, the local server 6 is preferably designed so that modification such as permutation of images or size change can be made. For example, a default template for each season may be inserted as album background in case of an automatic creation and the background may be modified by the administrator.

An electronic photo album so created is written to a recording medium such as CD-R and provided to the parent of a child. Instead, e-mail to which the electronic photo album is attached may be sent to the user terminal 8. The electronic photo album data may be stored in the network server 10 or local server 6 so that the parent who has been identified, can get access to the data to download it to his or her terminal 8.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

For example, although in the previous embodiment e-mail to which data of selected images or only information associated with the selected images is transmitted to the user terminal 8, data in an HTML format may be transmitted instead. However, e-mail is preferable in that information is automatically stored in a mailbox of a recipient when he or she is absent and the user does not need to get access to images. E-mail to which images are attached is more preferable.

Also, although in the previous embodiment an administrator of the local server 6 moves the images 104 stored in the individual folders 96 to the editor area 108 to create an electronic photo album in the manual mode, other operator such as minilab operator may create an electronic photo album instead.

Further, the storage section or device for storing images which have been captured may be located in the network server 10 instead of in the local server 6. Although it is possible to incorporate a storage section in each camera 4, it is preferably provided in the local server 6 or network server 10 in consideration of a miniaturization of each camera 4 and a unitary management of stored images.

Storage sections may be provided both in the local and network servers 6, 10. In this case, some of the image stored in the local server 6 may also be stored in the network server 10 so that only necessary images are open to the public. For example, images other than defocused images or background images without any children therein may be stored in the network server 10. Images selected in the local server 6 (e.g., important images which would be used for a yearbook, for example) may be backed up to the network server 10. The images may be backed up to the local server 6 instead.

Various corrections such as face recognition, white balance correction, contrast correction, color correction or sharpness correction may be made to images stored in the local or network server 6, 10, in order to enhance a quality of the images.

Where the user terminal 8 is a portable one, it is necessary to decrease the image resolution. For this purpose, for example, 1) the resolution is converted and the data is then stored in the local server 6, 2) the resolution is converted in the local server 6 to reduce the image data and the data is then transmitted to and stored in the network server 10, 3) the resolution is converted and the data is then stored in the network server 10.

It is noted that images for the distribution and/or album creation are not limited to images captured by the cameras 4 shown in FIG. 1. Images digitized by other digital camera or film scanner may be used instead.

According to the image service system of the present invention, appropriate images are automatically selected from a large amount of images which were taken and then transmitted to the user terminal 8, which allows the user to acquire desired images such as those of his or her child without getting access to the system.

Also, the system that enables an operator to select appropriate images from many images saves a user the trouble of getting access to the system and selecting desired images such as those of his or her child only.

Further, the system allows a set of images of a specified object to be easily collected.

What is claimed is:

1. An image service system comprising:
an imaging unit for capturing an image of an object; and
a server for storing a plurality of images captured by the imaging unit and selecting one or more desired images from the stored images;
wherein the server transmits the selected images or information associated with the selected images via a network to a terminal.

2. An image service system in accordance with claim 1, wherein the server includes information on a relationship between the object and a terminal; and
wherein the server selects one from a plurality of terminals to which the selected images or information associated with the selected images are transmitted, based on the information on the relationship and information on the object associated with the selected images.

3. An image service system in accordance with claim 1, wherein the imaging unit captures images with regard to a plurality of objects and wherein the server classifies the images captured by the imaging unit into a plurality sets of images per object, so that each classified set of images is selected as the desired images for each object.

4. An image service system in accordance with claim 1, wherein the server enhances a quality of the stored images.

5. An image service system in accordance with claim 1, wherein the server transmits the selected images or information associated with the selected images at a time which can be specified by an operator.

6. An image service system in accordance with claim 1, further comprising a second server for storing the desired images selected by said server.

7. An image service system in accordance with claim 1, wherein the server includes a storage section for storing a plurality of images captured by the imaging unit and a display device for displaying the images stored in the storage section;
wherein the server transmits images selected by an operator from the images displayed on the display device or information associated with the selected images via a network to a terminal.

8. A computer-readable recording medium, tangibly embodying a computer program for controlling an image service system comprising an imaging unit and a server connected with the imaging unit, the computer program including instructions for causing a computer in the server to implement a method comprising the steps of:
controlling the imaging unit to capture an image of an object;
storing a plurality of images captured by the imaging unit;
selecting one or more desired images from the stored images; and
transmitting the selected images or information associated with the selected images via a network to a terminal.

9. A computer-readable recording medium in accordance with claim 8, wherein the method further comprises the steps of storing information on a relationship between the object and a terminal; and selecting one from a plurality of terminals to which the selected images or information associated with the selected images are transmitted, based on the information on the relationship and information on the object associated with the selected images.

10. An image service system comprising:
an imaging unit for capturing an image in response to a user command transmitted from a user terminal located remote from the imaging unit and/or for automatically tracking one or more specific objects to capture images thereof; and
a server for selecting one or more groups of specific images from a plurality of images captured by the imaging unit.

11. An image service system in accordance with claim 10, wherein each group of specific images is a set of images of one of the specific objects.

12. An image service system in accordance with claim 10, wherein the server selects the one or more groups of specific images based on information given to each image when or after it was captured.

13. An image service system comprising:
an imaging unit for capturing an image in response to a user command transmitted from a user terminal located remote from the imaging unit and for automatically capturing an image at a given time; and
a server for selecting one or more groups of specific images from a plurality of images captured by the imaging unit.

14. An image service system in accordance with claim 13, wherein each group of specific images is a set of images of one of the specific objects.

15. An image service system in accordance with claim 13, wherein the server selects the one or more groups of specific images based on information given to each image when or after it was captured.

16. An image editing system for creating an electronic photo album, comprising:
an imaging unit for capturing an image in response to a user command transmitted from a user terminal located remote from the imaging unit and/or for automatically tracking a specific object to capture an image thereof; and
a server having a storage section for storing a first group of images captured by the imaging unit, wherein it selects a second group of images corresponding to a set of specific images from the first group of images, based on information regarding an object associated with each image of the first group of images.

17. An image editing system in accordance with claim 16, further comprising a display device for displaying the first group of images stored in the storage section of the server; and
wherein the server further comprises a second storage section for storing the second group of images, the second group being selected by an operator from the first group of images displayed on the display device.
